(19) United States
(12) Patent Application Publication
(10) Pub. No.: US 2023/0244277 A1
(43) Pub. Date: Aug. 3, 2023

(54) DISPLAY DEVICE

(71) Applicant: SHARP KABUSHIKI KAISHA, Sakai City, Osaka (JP)

(72) Inventor: TETSUO MURATA, Sakai City, Osaka (JP)

(21) Appl. No.: 18/007,885

(22) PCT Filed: Jun. 16, 2020
(86) PCT No.: PCT/JP2020/023556

§ 371 Date: Dec. 2, 2022

(51) Int. Cl. G06F 1/16; H04M 1/02

(52) U.S. Cl. CPC G06F 1/1656; G06F 1/1652; H04M 1/0268; G06F 1/1635; H04M 1/0262

(57) ABSTRACT

A display device includes the following: a flexible display body; and a support supporting the flexible display body, wherein the support has a hollow that enables intake/discharge of a gas. This can enhance the convenience of the flexible display body. An outer shape of the support is larger than an outer shape of the flexible display bod.

### TECHNICAL FIELD

The present invention relates to a display device.

### BACKGROUND ART

Patent Literature 1 for instance discloses, as a folding display device, a display that includes a flexible display body.

### CITATION LIST

### Patent Literature

Patent Literature 1: Japanese Unexamined Patent Application Publication (Translation of PCT application) No. 2018-537780

### SUMMARY OF INVENTION

### Technical Problem

By the way, a flexible display body, which flexes, normally has a support on its back surface (surface opposite to its display surface) to maintain the form of the flexible display body. For instance, a flexible display body alone that is used as a software keyboard flexes too much to be difficult to use; hence, providing a support on the backside of the flexible display body to reduce the flexure of the flexible display body and maintain its form, so that the flexible display body is easy to use.

The support, when provided on the backside of the flexible display body, can maintain the form of the flexible display body, but this increases the thickness of the entire device including the flexible display body and support, thus making it difficult to fold or roll up the flexible display body. That is, the flexibility of the flexible display body, which is its inherent function, cannot be unfortunately used effectively.

One aspect of the present invention aims to enhance the convenience of a flexible display body.

### Solution to Problem

To solve the above problem, a display device according to one aspect of the present invention includes the following: a flexible display body; and a support supporting the flexible display body, wherein the support has a hollow that enables intake/discharge of a gas.

### ADVANTAGEOUS EFFECT OF INVENTION

The aspect of the present invention can enhance the convenience of the flexible display body.

### BRIEF DESCRIPTION OF DRAWINGS

FIG. 1 is a schematic side view of a display device according to a first embodiment of the present invention.

FIG. 2 is a schematic side view of the display device shown in FIG. 1 with an intake/discharge device mounted thereon.

FIG. 3 schematically illustrates the configuration of a software keyboard including the display device shown in FIG. 1.

FIG. 4 schematically illustrates the configuration of a game controller including the display device shown in FIG. 1.

FIG. 5 is a schematic side view of a display device according to a second embodiment of the present invention.

FIG. 6 schematically illustrates a rollable display including the display device shown in FIG. 6.

FIG. 7 is a schematic side view of a display device according to a third embodiment of the present invention.

FIG. 8 illustrates a flexible display body and a support with the display device in FIG. 7 developed.

FIG. 9 illustrates example hook receivers provided on the flexible display body shown in FIG. 8, and example hooks provided on a support.

FIG. 10 illustrates the configuration of a support included in a display device according to a fourth embodiment of the present invention.

FIG. 11 illustrates other examples of a lattice shape that constitutes the support shown in FIG. 10.

FIG. 12 is a schematic side view of a display device according to a fifth embodiment of the present invention.

### DESCRIPTION OF EMBODIMENTS

### First Embodiment

The following details one embodiment of the present invention.

### Display Device

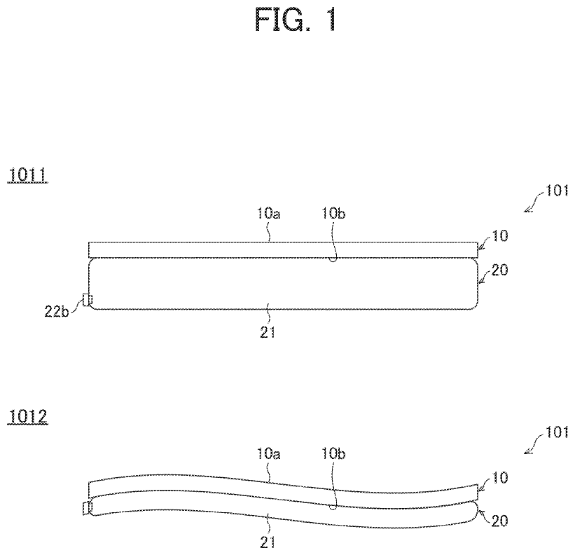

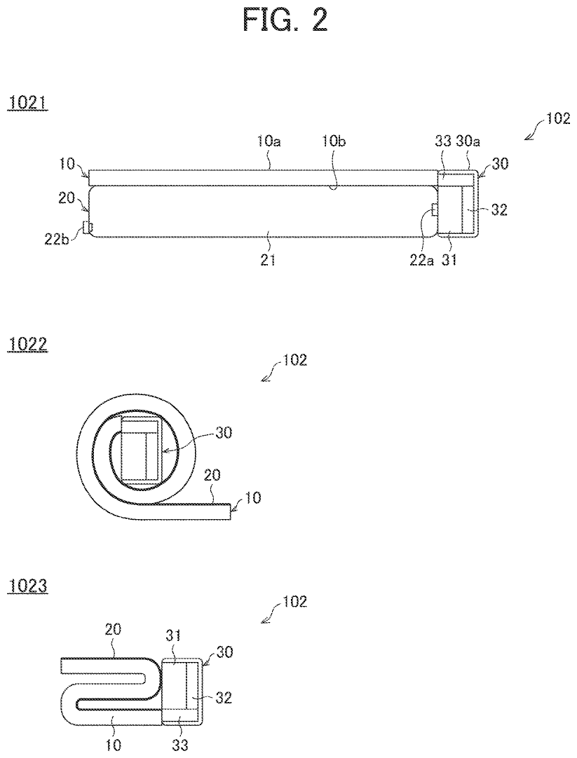

FIG. 1 illustrates an example display device 101 according to this embodiment. FIG. 2 illustrates a display device 102, which corresponds to the display device 101 shown in FIG. 1 with an intake/discharge device mounted thereon.

The display device 101 includes, as indicated by sign 1001 in FIG. 1, a flexible display body 10, and a support 20 disposed on a surface (back surface) 10b opposite to a display surface 10a of the flexible display body 10.

The flexible display body 10 is, for instance, a flexible organic light-emitting diode (OILED) panel or a flexible quantum dot panel.

The support 20 is made of a material with suppleness and includes the following: a hollow 21 being in intimate contact with the almost entire back surface 10b of the flexible display body 10, and being in the form of a bag into which gas is to be supplied; and an intake/discharge port 22 for taking in or letting out gas contained in the hollow 21.

The support 20 is as large as or smaller than the outer size of the flexible display body 10 so as not to be able to be seen from the display surface 10a of the flexible display body 10.

Upon receiving a predetermined or more amount of gas from the intake/discharge port 22, the hollow 21 inflates into a substantially rectangular shape, as indicated by sign 1011 in FIG. 1, and remains in a form (first form) for supporting the flexible display body 10 in such manner that the display surface 10a of the flexible display body 10 is almost flat.

Moreover, upon discharge of a predetermined or more amount of gas from the intake/discharge port 22, the hollow 21 deflates, as indicated by sign 1012 in FIG. 1, and releases the maintained form, in which the display surface 10a of the flexible display body 10 is almost flat, so that the flexibility of the flexible display body 10 can be used. This renders the flexible display body 10 at least partly flexed. That is, a transformation is made into a form (second form) in which the display device 101 including the flexible display body 10 can be rolled up or folded to be retracted.

In this way, the intake/discharge of gas contained in the hollow 21 brings the support 20 into the first form, in which a predetermined or more amount of gas is supplied to the hollow 21, or brings the support 20 into the second form, in which a predetermined or more gas is discharged from the hollow 21.

The hollow 21 may be a single hollow the support 20 or may be divided into a plurality of rooms. This example division into a plurality of rooms will be described later on in another embodiment.

The intake/discharge port 22 may be a single opening for intake-cum-discharge or may be provided separately for intake and discharge. Moreover, a plurality of intake/discharge ports 22 may be formed.

The intake/discharge of gas contained in the hollow 21 may be controlled by providing a stopper on the intake/discharge port 22, or by providing a relief valve on the intake/discharge port 22. That is, for a stopper provided on the intake/discharge port 22, this control is performed by removing the stopper to take a predetermined or more amount of gas from the intake/discharge port 22 into the hollow 21, followed by stoppering the intake/discharge port 22 to prevent gas leakage from the hollow 21, followed by unstoppering the intake/discharge port 22 to discharge gas from the hollow 21. Moreover, for a relief valve provided on the intake/discharge port 22, the intake/discharge of gas contained in the hollow 21 is controlled by opening/closing the relief valve.

There are two methods for putting gas into the hollow 21: (1) putting gas from an external compressor, and (2) putting gas from a built-in compressor.

Method (1), although applicable to all sizes irrespective of the size of a flexible display body, is suitable particularly for a large monitor and large signage. Method (2) is in contrast suitable for mobile apparatuses (e.g., tablets, smartphones, and mobile monitors) that include a flexible display body having a size of 20 inch or smaller for placing emphasis on portability.

It is noted that methods (1) and (2) are both applicable to both a method of maintaining form by stoppering an intake port upon a hollow of a support receiving gas to transform into a predetermined shape, and a method of maintaining the support in a predetermined form by putting gas from the intake port into the hollow of the support and discharging extra gas from a discharge port provided separately from the intake port. However, in method (2), continual gas supply causes the compressor's power to place a load on the battery; it is hence preferable to stopper the hollow to stop the compressor after the hollow inflates.

FIG. 2 illustrates an example display device 102, which embodies method (2), i.e., putting gas from a built-in compressor. That is, the display device 102 further includes, as indicated by sign 1021 in FIG. 2, a compressor device 30 for putting gas into the hollow 21 of the support 20. The compressor device 30 is disposed on one of the ends of the support 20 and includes, within a case 30a, a compressor 31 for putting gas into the hollow 21, and a battery 32 as well as a drive circuit 33 both for driving the compressor 31.

Unlike the display device 101 shown in FIG. 1, the display device 102 is configured such that an intake port 22a for gas intake into the hollow 21, and a discharge port 22b for gas discharge are separately provided. The intake port 22a is formed on the support 20 adjacent to the compressor device 30 so as to communicate with a gas supply port of the compressor 31 of the compressor device 30, and the discharge port 22b is formed in a location on the support 20 facing the intake port 22a. The discharge port 22b is stoppered so that the hollow 21 with gas therein remains in a predetermined form and so that the taken gas does not leak.

Accordingly, when the discharge port 22b is unstoppered with the hollow 21 of the support 20 filled with a predetermined amount of gas, that is, with the display surface 10a of the flexible display body 10 remaining flat, as indicated by sign 1021 in FIG. 2, gas within the hollow 21 discharges outside, thus causing the support 20 to at least partly deflate, thereby enabling the flexible display body 10 to be rolled up around the compressor device 30 to be retracted, as indicated by sign 1022 in FIG. 2, or enabling the flexible display body 10 to be folded to be retracted, as indicated by sign 1023 in FIG. 2.

Adding the function of a touch panel to the flexible display body 10 can apply the present invention to software keyboards and game controllers.

### Software Keyboard

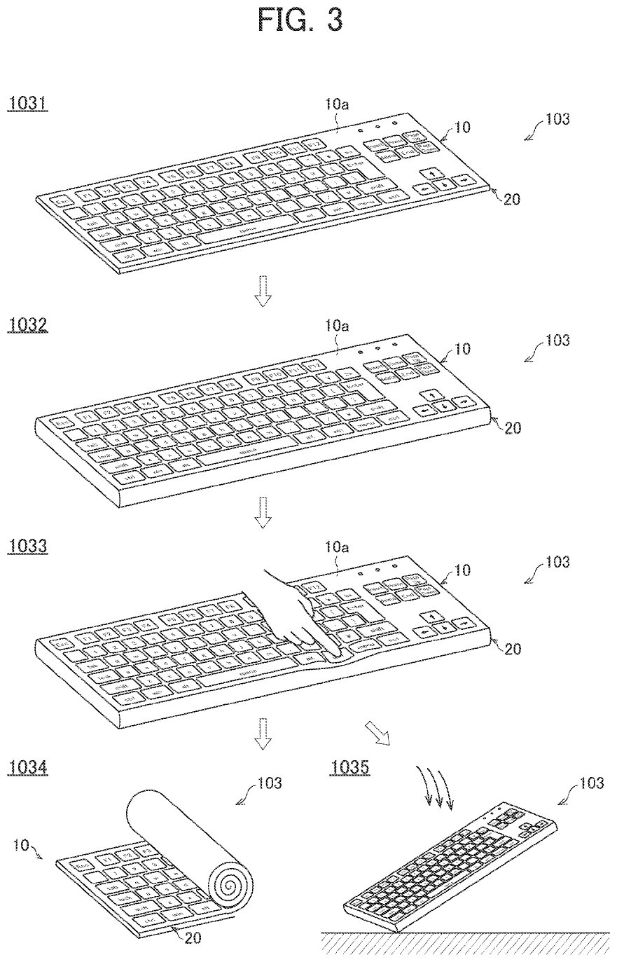

FIG. 3 illustrates an example display device 103 incorporated in a software keyboard.

The display device 103 achieves a software keyboard by, as indicated by sign 1031 in FIG. 3, adding the function of a touch panel to the display surface 10a of the flexible display body 10.

For the display device to function as a software keyboard, the hollow 21 (not shown) of the support 20 undergoes gas supply to inflate until a keyboard image displayed on the display surface 10a of the flexible display body 10 becomes flat, as indicated by sign 1032 in FIG. 3. This enables the thickness of the display device 103 to be close to the thickness of a physical keyboard, so that the keyboard displayed on the display surface 10a of the display device 103 has such a height that a user easily uses the keyboard, as indicated by sign 1033 in FIG. 3.

The display device 103, when not used as a software keyboard, becomes thin by releasing gas from the hollow 21 of the support 20 to deflate the hollow 21 and can be thus rolled up, as indicated by sign 1034 in FIG. 3.

In addition, the support 20 serves as a cushion; hence, if the display device 103 is slipped off for instance to drop, as indicated by sign 1035 in FIG. 3, the display device 103 does not break.

### Game Controller

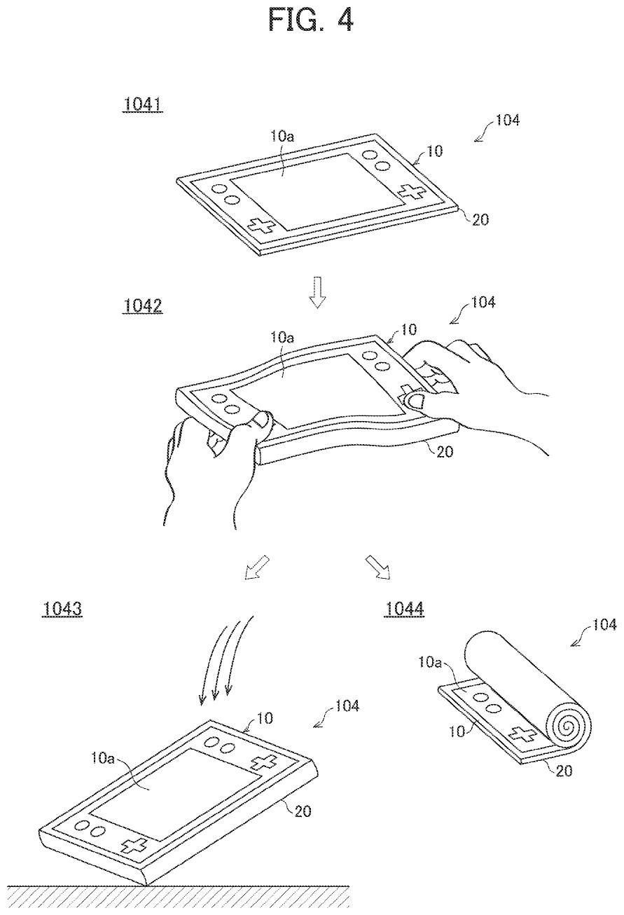

FIG. 4 illustrates an example display device 104 incorporated in a game controller.

The display device 104 achieves a game controller by, as indicated by sign 1041 in FIG. 4, adding the function of a touch panel to the display surface 10a of the flexible display unit 10.

For the display device to function as a game controller, the hollow 21 (not shown) of the support 20 undergoes gas supply to inflate until it has such a thickness that a user easily operates the game controller, as indicated by sign 1042 in FIG. 4. This enables the thickness of the display device 104 to be close to the thickness of a physical game controller, so that the game controller has such a height that the user easily uses the game controller.

In addition, the display device 104, which has the support 20 that is inflated to be thick, is easy to hold by both hands and facilitates game operations. Furthermore, the user can operate the display device 104 while twisting the display device 104 in a position where the user can use it easily, as indicated by sign 1042 in FIG. 4, and hence gets less tired.

Moreover, the support 20 serves as a cushion; hence, if the user gets so excited during a game that the user drops the display device 104, as indicated by sign 1043 in FIG. 4, the display device 104 does not break.

The display device 104, when not used as a game controller, becomes thin by releasing gas from the hollow 21 of the support 20 to deflate the hollow 21 and can be thus rolled up, as indicated by sign 1044 in FIG. 4.

The first embodiment has described an instance where the hollow 21 of the support 20 undergoes gas supply with the flexible display body 10 developed, to be thus ready for use. A second embodiment below will describe an instance where the hollow 21 of the support 20 undergoes gas supply with the flexible display body 10 rolled up (in a retractable state), to thus develop the flexible display body 10 to be ready for use.

### Second Embodiment

The following describes another embodiment of the present invention. It is noted that for convenience in description, components having the same functions as components described in the foregoing embodiment will be denoted by the same signs, and the description of the same components will not be repeated.

### Rolled Display

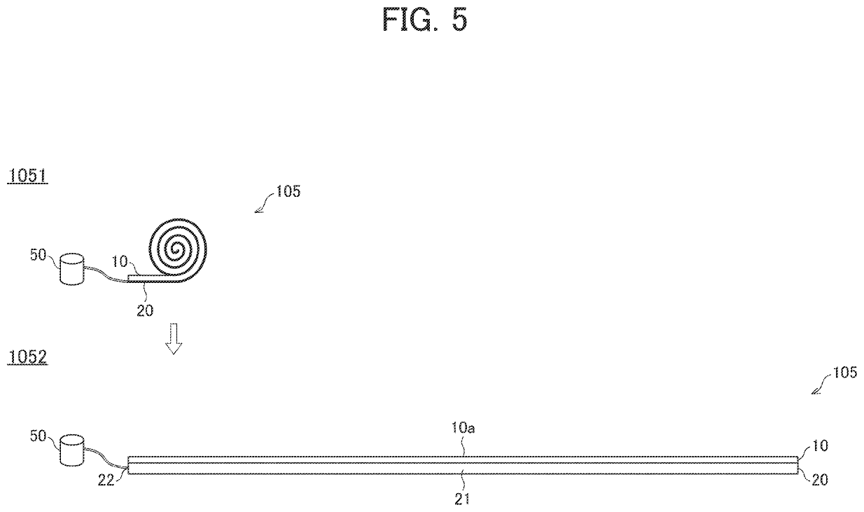

FIG. 5 schematically illustrates the configuration of a display device 105 according to this embodiment.

Upon gas supply from the compressor 50 to the hollow 21, with the display device 105 rolled up as indicated by sign 1051 in FIG. 5, the display surface 10a of the flexible display body 10 becomes flat (that is, the flexible display body 10 is ready for use), as indicated by sign 1052 in FIG. 5. That is, supplying gas from the compressor 50 to the hollow 21 of the support 20 causes the display device 105 to extend like a toy called fukimodoshi without manual deployment, from a pre-use state, where the display device 105 is rolled up like a scroll, to thus automatically develop.

Furthermore, in the display device 105 that is structured to incorporate a metal (shape-memory metal) thin curly wire rod, releasing gas from the hollow 21 of the support 20 brings the wire rod back into a memorized curly state.

### Modification

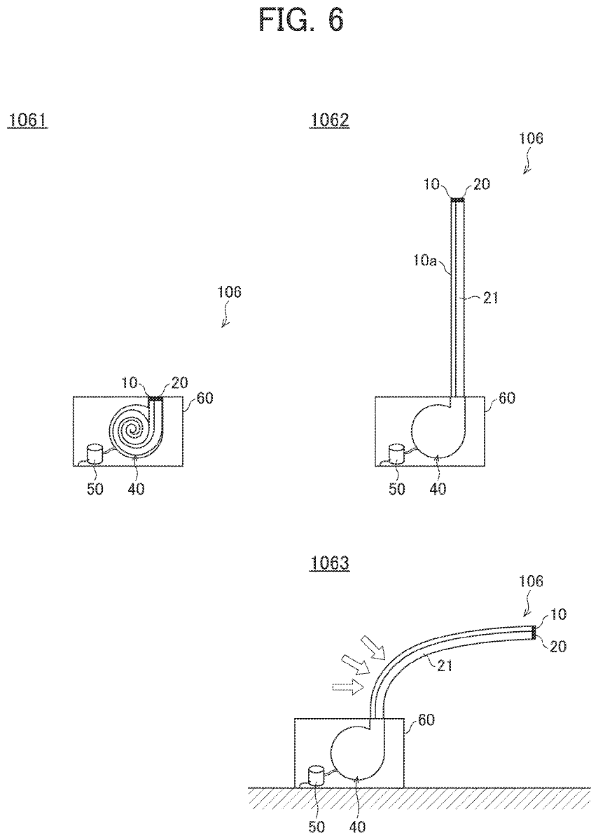

FIG. 6 schematically illustrates the configuration of a rollable display 106 that includes the display device 105 shown in FIG. 5.

The rollable display 106 rolls up the flexible display body 10 and the support 20 to house them in a container (roll-up unit) 60 and extends them as necessary from the container 60 to function as a display unit. That is, for the rollable display 106 to function as a display unit, the flexible display body 10 undergoes transformation from a state where, as indicated by sign 1061 in FIG. 6, the flexible display body 10 and the support 20 are housed in the container 60 (this state will be referred to as a retracted state) into a state where, as indicated by sign 1062 in FIG. 6, the display surface 10a is flat (this state will be referred to as a developed state).

The container 60 includes the following, as indicated by sign 1061 in FIG. 6: a roller 40 for rolling up the flexible display body 10 and the support 20; and a compressor 50 that supplies gas to the hollow 21 of the support 20. The roller 40 is driven by a motor (not shown) and is a means for rolling up and sending out the flexible display body 10 and the support 20. The compressor 50 is designed to supply gas fro an intake/discharge port (not shown) of the support 20 to the hollow 21.

For sending out the flexible display body 10 and the support 20 from the container 60, supplying gas from the compressor 50 to the hollow 21 in accordance with the sending-out timing of the roller 40 causes the flexible display body 10 and the support 20 to develop upward while standing on their own, so that, as indicated by sign 1062 in FIG. 6, the flexible display body 10 is in a state where the display surface 10a is flat (developed state).

It is noted that once a predetermined amount of gas is supplied to the hollow 21, the support 20 discharges gas little by little from the hollow 21 via a discharge port that is different from the intake/discharge port connected to the compressor 50, to thus support, as indicated by sign 1062 in FIG. 6, the flexible display body 10 in such a manner that the display surface 10a remains flat. Moreover, the support 20 deflates as a result of gas release from the hollow 21 when the compressor 50 stops. The deflated support 20 is rolled up together with the flexible display body 10 by the roller 40 to be, as indicated by sign 1061 in FIG. 6, brought into the state where they are housed in the container 60 (retracted state).

The rollable display 106, which is designed to always supply gas from the compressor 50 to the hollow 21 in the developed state, flexes without breakage to avoid a stress, as indicated by sign 1063 in FIG. 6, even if such a stress is applied to the flexible display body 10 and the support 20 from their front or back due to physical power, wind, earthquake shock, or other factors, so that the flexible display body 10 can maintain its original shape again.

It is noted that this embodiment has described an instance where the flexible display body 10 and the support 20 are integrally formed and are rolled up by a single roller 40. The following embodiment will describe an instance where the flexible display body 10 and the support 20 are rolled up separately by different rollers and are then integrated when taken out.

### Third Embodiment

The following describes another embodiment of the present invention. It is noted that for convenience in description, components having the same functions as components described in the foregoing embodiments will be denoted by the same signs, and the description of the same components will not be repeated.

### Outline of Rollable Display

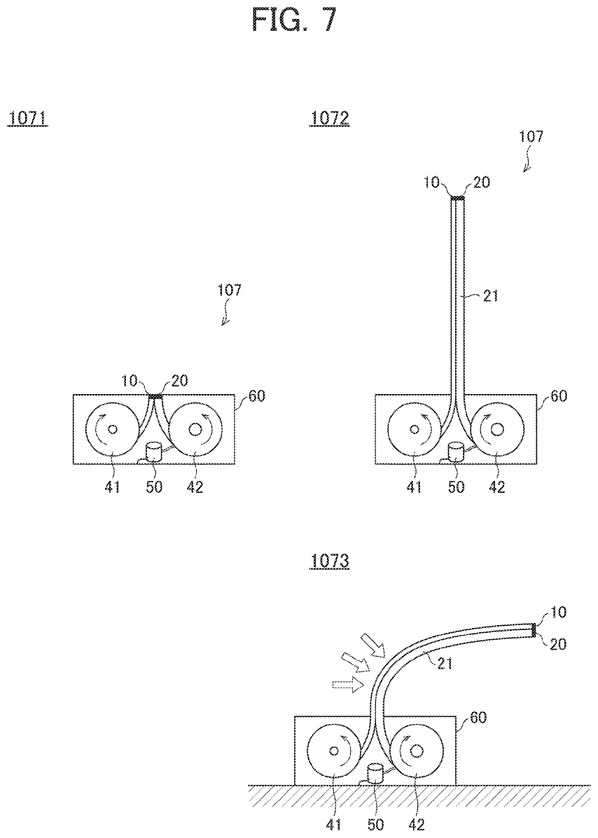

FIG. 7 schematically illustrates the configuration of a rollable display 107 according to this embodiment.

The rollable display 107 rolls up the flexible display body 10 and the support 20 to house them in the container (roll-up unit) 60 and extends them as necessary from the container 60 to function as a display unit. That is, for the rollable display 107 to function as a display unit, the flexible display body 10 undergoes transformation from a state where, as indicated by sign 1071 in FIG. 7, the flexible display body 10 and the support 20 are housed in the container 60 (this state will be referred to as a retracted state) into a state where, as indicated by sign 1072 in FIG. 7, the display surface 10a is flat (this state will be referred to as a developed state).

As indicated by sign 1071 in FIG. 7, the container 60 has a first roller 41 around which the flexible display body 10 is rolled, and a second roller 42 around which the support 20 that is in a form (second form) where the flexible display body 10 is flexed is rolled, and the container 60 further includes the compressor 50 that supplies gas to the hollow 21 of the support 20. The first roller 41 and the second roller 42 are driven by a motor (not shown) and are means for rolling up and sending out the respective flexible display body 10 and support 20. The compressor 50 is designed to supply gas from the intake/discharge port (not shown) of the support 20 to the hollow 21.

For sending out the flexible display body 10 and the support 20 from the container 60, supplying gas from the compressor 50 to the hollow 21 in accordance with the sending-out timing of the roller 41 and second roller 42 causes the flexible display body 10 and the support 20 to be integrated together while being in intimate contact near the exit of the container 60, and to then develop upward while standing on their own, so that, as indicated by sign 1072 in FIG. 7, the flexible display body 10 is in a state where the display surface 10a is flat (developed state).

It is noted that once a predetermined amount of gas is supplied to the hollow 21, the support 20 discharges gas little by little from the hollow 21 via a discharge port that is different from the intake/discharge port connected to the compressor 50, to thus support, as indicated by sign 1072 in FIG. 7, the flexible display body 10 in such a manner that the display surface 10a. remains flat (developed state). Moreover, the support 20 deflates as a result of gas release from the hollow 21 when the compressor 50 stops. The deflated support 20 and flexible display body 10 undergo separation near the exit of the container 60; then, the support 20 and the flexible display body are respectively rolled up by the second roller 42 and the first roller 41 to be thus, as indicated by sign 1071 in FIG. 7, in a state where they are housed in the container 60 (retracted state).

The rollable display 107 with the foregoing configuration is structured such that the flexible display body 10 and the support 20, when housed, are separated and are rolled around two different rollers (the first roller 41 and the second roller 42). Moreover, the first roller 41 and the second roller 42 are disposed so as to rotate in mutually opposite directions. That is, when the flexible display body 10 and the support 20 undergo roll-up, the first roller 41 rotates clockwise, and the second roller 42 rotates counterclockwise. In contrast, when the flexible display body 10 and the support 20 undergo sending-out, the first roller 41 rotates counterclockwise, and the second roller 42 rotates clockwise. A flexible sheet in the form of a roll, when spread, normally receives a stress in a direction where the sheet curves outward. As such, the flexible display body 10 and the support 20, which are sent out from the container 60 by rotating the first roller 41 and the second roller 42 in mutually opposite directions, have their respective curving directions opposite to each other (mutually dragging directions) to thus cancel out power each other, and the flexible display body 10 and the support 20 hence easily become in an upright position. In this case, the support 20 undergoes material and thickness adjustment in accordance with a bending stress that is exerted on the flexible display body 10.

Moreover, the rollable display 107, which is designed to always supply gas from the compressor 50 to the hollow 21 in the developed state, flexes without breakage to avoid a stress, as indicated by sign 1073 in FIG. 7, even if such a stress is applied to the flexible display body 10 and the support 20 from their front or back due to physical power, wind, earthquake shock, or other factors, so that the flexible display body 10 can maintain its original shape again.

### How Support Supports Flexible Display Body

One way to couple the flexible display body 10 and the support 20 together for development, and to separate the flexible display body 10 and the support 20 from each other for retraction is attaching hooks to the support 20 at appropriate intervals, and attaching hook receivers to corresponding locations on the flexible display body 10.

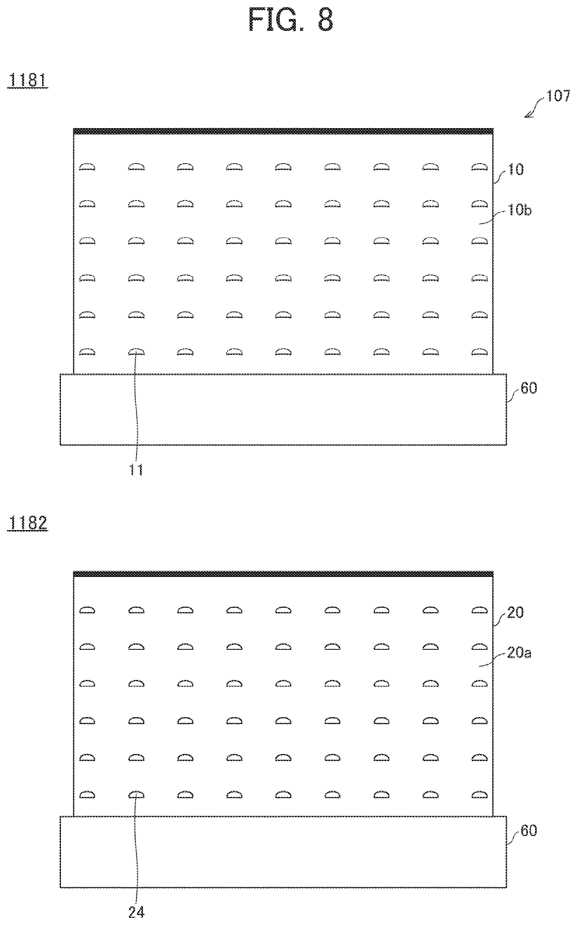

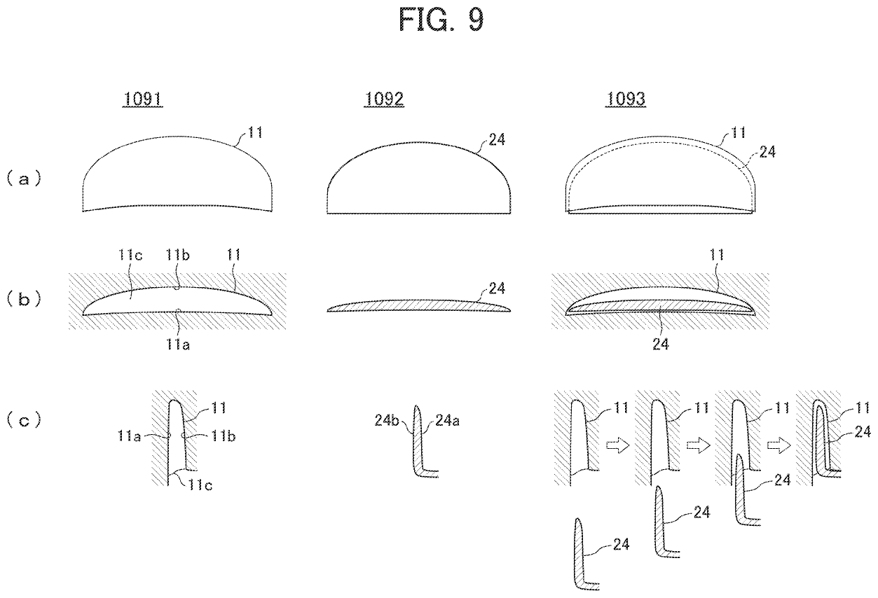

FIG. 8 illustrates the developed flexible display body 10 and support 20. FIG. 9 illustrates example hook receivers provided on the flexible display body 10 shown in FIG. 8, and example hooks provided on the support 20 shown in FIG. 8. It is noted that FIG. 9(a) is a front view, FIG. 9(b) is a sectional view, and FIG. 9(c) is a side view.

The back surface 10b has hook receivers (recesses) 11 provided at regular intervals on the back surface 10b, as indicated by sign 1181 in FIG. 8. The support 20 has hooks (protrusions) 24 provided at regular intervals on an opposed surface 20a facing the flexible display body 10 of the flexible display body 10, and that are inserted into the hook receivers 11. As many hooks 24 as the hook receivers 11 are provided in locations corresponding to where the hook receivers 11 of the flexible display body 10 are provided.

The hook receivers 11 are for inserting the hooks 24 of the support 20 thereinto and are each in the form of a bag consisting of the following, as indicated by sign 1091 in FIG. 9: a surface 11a adjacent to the back surface 10b of the flexible display body 10 and being almost flat; a surface 11b facing the surface 11 a and being curved; and an opening 11c formed below.

The hooks 24 are each, as indicated by sign 1092 in FIG. 9, in the form of such a downward protrusion that a surface 24a of the opposed surface 20a of the support 20 remains spaced from the opposed surface 20a at a predetermined spacing. Furthermore, the hooks 24 are each in such a form as to be able to be inserted into the hook receivers 11 of the flexible display body 10 from the surface 24b, which faces the surface 24a of the opposed surface 20a of the support 20.

Once inserted into the hook receivers 11, the hooks 24 are almost covered with the hook receivers 11, as indicated by sign 1093 in FIG. 9. The support 20 in this case holds up and supports the flexible display body 10. That is, the hooks 24 support the hook receivers 11 from below when the hook receivers 11 and the hooks 24 are fitted together. That is, the back surface 10b of the flexible display body 10 is engaged in the support 20 that is in the first form, where the support 20 rises to render the display surface of the flexible display body flat.

Here, adding the function of a magnet to both of the hook receivers 11 and hooks 24, and furthermore, adding such magnetic-field directions that the hooks 24 and the hook receivers 11 attract each other to the respective hooks 24 and hook receivers 11 enable the hooks 24 to be easily fitted into the hook receivers 11.

It is noted that how to couple the flexible display body 10 and the support 20 together for development, and to separate the flexible display body 10 and the support 20 from each other for retraction is not limited to such a method as described above, in which the hook receivers 11 and the hooks 24 are used. Examples of the method of coupling and separation may include, but not limited to, the following: providing a magnet or a magnet sheet on each of the facing surfaces (10b and 20a) of the respective flexible display body 10 and support 20, to thus couple the flexible display body 10 and the support 20 together for development, and to separate the flexible display body 10 and the support 20 from each other for retraction; and subjecting the flexible display body 10 and the support 20 to electrification using an electrifier to bring them into intimate contact for development, and subjecting them to electricity elimination using an electricity eliminator to separate them from each other for retraction.

It is noted that the foregoing embodiment has described a non-limiting instance where the support 20 is of hollow structure in the form of a single bag, which is herein the hollow 21, with no partition. For instance, a hollow structure may be used like one in a fourth embodiment that will be described below, where the hollow 21 is sectioned into a plurality of hollows.

### Fourth Embodiment

The following describes another embodiment of the present invention. It is noted that for convenience in description, components having the same functions as components described in the foregoing embodiments will be denoted by the same signs, and the description of the same components will not be repeated. It is noted that the rollable display according to this embodiment is structured in almost the same manner as the rollable display 107 shown in FIG. 7 in the third embodiment, but they are different in the structure of the support 20.

### Structure of Support

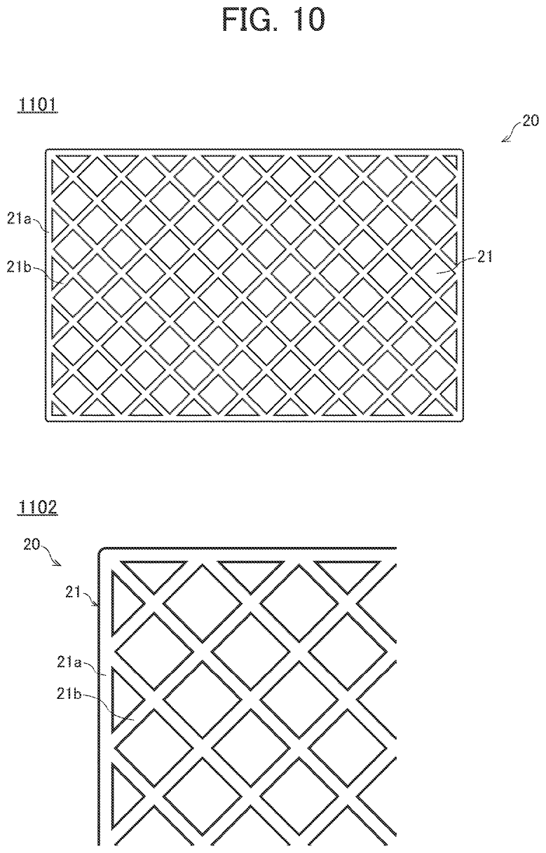

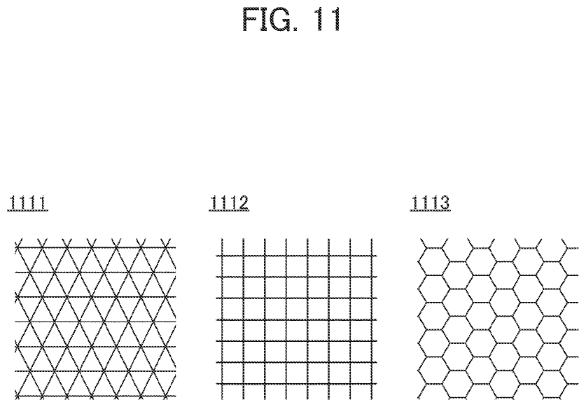

FIG. 10 illustrates example structures where t hollow 21 of the support 20 according to this embodiment is sectioned into a plurality of hollows. FIG. 11 illustrates example lattices that constitutes the support 20.

The hollow 21 of the support 20 is composed of a plurality of ventilation paths communicating, as indicated by sign 1101 in FIG. 10. The hollow 21 is specifically composed of a plurality of first ventilation paths 21a arranged on the four sides, and a plurality of second ventilation paths 21b arranged inside in an oblique-lattice manner. The first ventilation paths 21a and the second ventilation paths 21b undergo gas supply to inflate the hollow 21, thus constituting the support 20. That is, the support 20 is composed of a plurality of hollows 21 arranged in a planar manner.

When the lattice shape of the hollow 21 is a rhombus, the second ventilation paths 21b are preferably arranged in such a manner that the interval between the second ventilation paths 21b adjacent to each other is 1 to 2 times inclusive of the width of each ventilation path, For the flexible display body 10 having a display size of 32 inch (an aspect ratio of 16:9) for instance, the second ventilation paths 21b of 1.5 cm in diameter are arranged at intervals of about 2.3 cm when the inner diameters of the second ventilation paths 21b (the diameters of cylindrical paths for gas) are set at 1.5 cm, and when the interval between the second ventilation paths 21b adjacent to each other is set at 1.5 times of the diameters of the second ventilation paths 21b (the diameters of the cylinders). At this time, 30 second ventilation paths 21b positively sloped at 45° are arranged laterally, and about 30 second ventilation paths 21b negatively sloped at −45° are similarly arranged laterally. The second ventilation paths 21b are connected at intersections 21c while penetrating each other, as indicated by sign 1102 in FIG. 10.

The hollow 21 of the support 20, when being in the form of a single bag, is inflated toward its center in a plan view upon receiving gas, thus resulting in a bad-looking appearance in a lateral view. Moreover, such inflation makes it difficult to bend the support 20 equally.

However, such a structure as the support 20 with the foregoing configuration, where the hollow 21 is sectioned into a plurality of smaller hollows (the first ventilation paths 21a and the second ventilation paths 21b), enables the support 20 to inflate to a uniform thickness even when the support 20 per se becomes large, thus achieving a good-looking appearance in a lateral view. In addition, many second ventilation paths 21b in the form of a lattice, when provided, can improve the strength of the support 20 per se to function as the skeleton of the support 20.

The sizes of the first ventilation paths 21a and second ventilation path 21b constituting the hollow 21 are non-limiting; their sizes need to be set as appropriate in view of the screen size of the flexible display body 10 and the bending performance of the flexible display body 10.

Moreover, although the first ventilation paths 21a and the second ventilation paths 21b may have any shape in the form of a hollow, they preferably have a cylindrical shape. This is because that a cylinder commonly involves a less loss of head (a loss of energy that hinders liquid flow or gas flow).

Here, based on the premise that the gas paths are cylinders, the number (density) of lattices reduces along with increase in the sectional thickness of the second ventilation paths 21b that constitute a lattice. That is, the thickness of the support 20 increases along with increase in the sectional thickness of the second ventilation paths 21b, thus resulting in a bad-looking appearance. In contrast, the thickness of the support 20 reduces along with decrease in the sectional thickness of the second ventilation paths 21b that constitute a lattice, achieving a good-looking appearance, but the power of the support 20 for supporting the flexible display body 10 becomes weak. That is, the support 20 bends easily even when inflated by gas.

As such, the size of the lattice (the sectional size of the second ventilation paths 21b) needs to be set in view of the balance between bending degree and appearance (thickness) at the time of application of an external force.

The shape of the divided hollow 21 is an oblique-lattice shape (rhombus), as indicted by sign 1101 in FIG. 10, The divided hollow 21 has such a rhombus shape as described above, thus achieving both smooth upward gas flow and strength. Furthermore, in view of vertical bending resulting from an external force, such a rhombus shape avoids an undesired curve, because a bend is always made from a portion at a lateral corner.

However, the shape of the divided hollow 21 is not limited to what is illustrated in FIG. 10, sign 1101, i.e., an oblique-lattice shape (rhombus); a plurality of second ventilation paths 21b need to be arranged in a lattice manner or a planar honeycomb manner. Examples of their arrangement may include, but not limited to, what is illustrated in FIG. 11, sign 1111, i.e., a triangular manner, what is illustrated in FIG. 11, sign 1112, i.e., a quadrangular manner, and what is illustrated in FIG. 11, sign 1113, i.e., a hexagonal manner.

### Fifth Embodiment

The following describes another embodiment of the present invention. It is noted that for convenience in description, components having the same functions as components described in the foregoing embodiments will be denoted by the same signs, and the description of the same components will not be repeated.

### Outline of Rollable Display

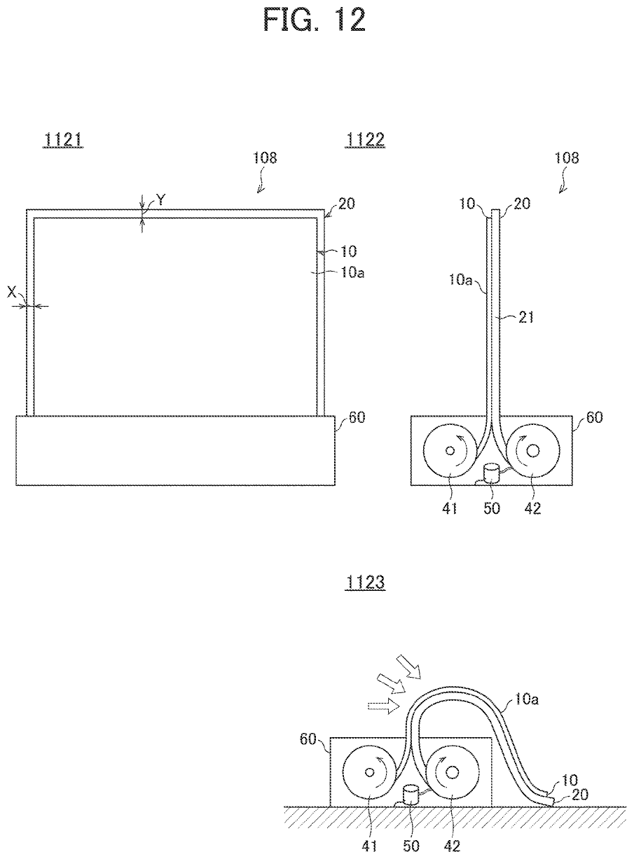

FIG. 12 schematically illustrates the configuration of a rollable display 108 according to this embodiment.

The rollable display 108 is structured in almost the same manner as the rollable display 107 shown in FIG. 7 in the third embodiment, but they are different in that the support 20 has a size larger than the size of the flexible display body 10. That is, the support 20 in the rollable display 108 has an outer shape larger than the outer shape of the flexible display body 10. Accordingly, the retraction and development of the flexible display body 10 and support 20, which are the same as those in the rollable display 107, will not be described.

The support 20 has such an outer size as to, as indicated by sign 1121 in FIG. 12, protrude from the outer shape of the flexible display body 10 by X cm laterally and by Y cm longitudinally. The support 20 protrudes outward from the flexible display body 10, thereby enabling the side edge of the flexible display body 10 to be protected. For instance, the protruding portions of the support 20 can protect the edge of the flexible display body 10, as indicated by sign 1123 in FIG. 12, even if the flexible display body 10 receives an external force (such as wind), with the flexible display body 10 and support 20 developed, as indicated by sign 1122 in FIG. 12, and thus falls down toward the support 20.

It is noted that in the support 20 protruding from the flexible display body 10, the frame edge of the flexible display body 10 seemingly widens, resulting in a bad-looking appearance, but this configuration is effective when emphasis is placed on reliability, that is, protecting the flexible display body 10.

### Summary

A display device according to a first aspect of the present invention includes the following: a flexible display body (10); and a support (20) supporting the flexible display body (10), wherein the support (20) has a hollow (21) that enables intake/discharge of a gas.

In the foregoing configuration, the support supporting the flexible display body, which has a hollow that enables gas intake/discharge, can change shape depending on a gas amount to be supplied to the hollow and can also change the form of the flexible display body, supported by the support, along with a change in the shape of the support. For instance, increasing the gas amount to be supplied to the hollow can maintain the support in a desired form, thereby enabling the flexible display body to be maintained in a desired form. In contrast, reducing the gas amount to be supplied to the hollow, or discharging gas from the inflated hollow can no longer maintain the support in the desired form, thereby no longer enabling the flexible display body to be maintained in the desired form. As such, once a flexible display can be no longer maintained in a desired form, the flexibility of the flexible display body can be used. Changing the amount of gas within the hollow, as described above, changes the shape of the support as well, thus enabling the flexible display body supported by the support to also change form along with a change in the form of the support. This can enhance the convenience of the flexible display body.

The display device according to a second aspect of the present invention is preferably configured, in the first aspect, such that the support (20) is brought into a first form upon intake of a predetermined or more amount of gas into the hollow (21), and the support is brought into a second form upon discharge of a predetermined or more amount of gas from the hollow (21).

The foregoing configuration enables the flexible display body to take at least two types of form in accordance with the amount of gas contained in the hollow.

The display device according to a third aspect of the present invention may be configured, in the second aspect, such that the support (20) is fastened to the back surface (10a) of the flexible display body (10).

The display device according to a fourth aspect of the present invention may be configured, in the third aspect, such that the first form is a form that renders the display surface (10a) of the flexible display body (10) flat, and such that the second form is a form that renders the flexible display body (10) at least partly flexed.

In the foregoing configuration, the support takes the first form, thus enabling the flexible display body to be in a function execution state for functioning as a display device, and the support takes the second form, thus enabling flexible display body to be in a retracted state for folding and retraction.

The display device according to a fifth aspect of the present invention may be configured, in any one of the first to fourth aspects, such that the outer shape of the support (20) is larger than the outer shape of the flexible display body (10).

The foregoing configuration enables the support not only to support the flexible display body, but also to protect the flexible display body using portions protruding from the flexible display body. For instance, let the flexible display body that is used as a rollable display be made to stand on its own; accordingly, the flexible display body, even if falling down in response to an external force, is protected by the protruding portions of the support.

The display device according to a sixth aspect of the present invention may be configured, in any one of the first to fifth aspects, such that the hollow is composed of a plurality of ventilation paths (first ventilation paths 21a, second ventilation paths 21b) communicating.

The display device according to a seventh aspect of the present invention may be configured, in the sixth aspect, such that the plurality of ventilation paths (second ventilation paths 21b) are arranged in a lattice manner or a planar honeycomb manner.

The display device according to an eighth aspect of the present invention may be configured, in the seventh aspect, such that the plurality of ventilation paths (second ventilation paths 21b) are arranged in an oblique-lattice manner.

The display device according to a ninth aspect of the present invention is preferably configured, in the eighth aspect, such that the interval between the plurality of ventilation paths (second ventilation paths 21b) adjacent to each other is set to 1 to 2 times inclusive of the width of each of the plurality of ventilation paths (second ventilation paths 21b).

In the foregoing configuration, the support, which is composed of a plurality of hollows arranged in a planar manner, can have a uniform thickness without having an inflated middle, which is seen in an instance where the support is composed of a single hollow.

In the second aspect, the display device according to a tenth aspect of the present invention may include a roll-up unit (container 60) configured to roll up the flexible display body (10) and the support (20) that is in the second form, wherein the roll-up unit (container 60) may have a first roller (41) around which the flexible display body (10) is rolled up, and a second roller (42) around which the support (2) that is in the second form is rolled up.

The display device according to an eleventh aspect of the present invention may be configured, in the tenth aspect, such that the back surface (10a) of the flexible display body (10) extended from the first roller (41) is engaged in the support (20) extended from the second roller (42) to transform from the second form into the first form.

The display device according to a twelfth aspect of the present invention may be configured, in the eleventh aspect, such that the back surface (10a) of the flexible display body (10) is provided with a plurality of recesses (hook receivers 11), and such that the support (2) is provided with a plurality of protrusions (hooks 24) engaging in the plurality of recesses (hook receivers 11).

In any one of the first to twelfth aspects, the display device according to a thirteenth aspect of the present invention may include the following: a compressor (31) configured to perform intake/discharge of the gas; and a battery (32) configured to supply power to the compressor (31).

The display device according to a fourteenth aspect of the present invention may be configured, in any one of the first to thirteenth aspects, such that the flexible display body is a flexible OLED panel.

The present invention is not limited to the foregoing embodiments. Various modifications can be devised with the scope of the claims. An embodiment that is obtained in combination, as appropriate, with the technical means disclosed in the respective embodiments is also included in the technical scope of the present invention. Furthermore, combining the technical means disclosed in the respective embodiments can form a new technical feature.

### REFERENCE SIGNS LIST

10 flexible display body

10a display surface

10b back surface

11 hook receiver

20 support

20a opposed surface

21 hollow

21a first ventilation path

21b second ventilation path

21c intersection

22 intake/discharge port

22a intake port

22b discharge port

24 hook

30 compressor device

30a case

31 compressor

32 battery

33 drive circuit

40 roller

41 first roller

42 second roller

50 compressor

60 container (roll-up unit)

101, 102, 103, 104, 105 display device

106, 107, 108 rollable display

What is claimed is:

1. A display device comprising:
a flexible display body; and
a support supporting the flexible display body,
wherein the support has a hollow that enables intake/discharge of a gas, and an outer shape of the support is larger than an outer shape of the flexible display body.

2. The display device according to claim 1, wherein the support is brought into a first form upon intake of a predetermined or more amount of gas into the hollow, and the support is brought into a second form upon discharge of a predetermined or more amount of gas from the hollow.

3. The display device according to claim 2, wherein the support is fastened to a back surface of the flexible display body.

4. The display device according to claim 3, wherein
the first form is a form that renders a display surface of the flexible display body flat, and
the second form is a form that renders the flexible display body at least partly flexed.

5. (canceled)

6. The display device according to claim 1, wherein the hollow is composed of a plurality of ventilation paths communicating.

7. The display device according to claim 6, wherein the plurality of ventilation paths are arranged in a lattice manner or a planar honeycomb manner.

8. The display device according to claim 7, wherein the plurality of ventilation paths are arranged in an oblique-lattice manner.

9. The display device according to claim 8, wherein an interval between the plurality of ventilation paths adjacent to each other is set to 1 to 2 times inclusive of a width of each of the plurality of ventilation paths.

10. A display device comprising:
a flexible display body; and
a support supporting the flexible display body,
wherein the support has a hollow that enables intake/discharge of gas,
the support is brought into a first form upon intake of a predetermined or more amount of gas into the hollow, and
the support is brought into a second form upon discharge of a predetermined or more amount of gas from the hollow, and
further comprising a roll-up unit configured to roll up the flexible display body and the support that is in the second form,
wherein the roll-up unit has
a first roller around which the flexible display body is rolled up, and a second roller around which the support that is in the second form is rolled up.

11. The display device according to claim 10, wherein a back surface of the flexible display body extended from the first roller is engaged in the support extended from the second roller to transform from the second form into the first form.

12. The display device according to claim 11, wherein the back surface of the flexible display body is provided with a plurality of recesses, and the support is provided with a plurality of protrusions engaging in the plurality of recesses.

13. The display device according to claim 1, comprising: a compressor configured to perform intake/discharge of the gas; and a battery configured to supply power to the compressor.

14. The display device according to claim 1, wherein the flexible display body is a flexible OLED panel.

15. A display device comprising:
a flexible display body; and
a support supporting the flexible display body,
wherein the support has a hollow that enables intake/discharge of a gas, and
the hollow is composed of a plurality of ventilation paths communicating.

16. The display device according to claim 15, wherein the plurality of ventilation paths are arranged in a lattice manner or a planar honeycomb manner.

17. The display device according to claim 16, wherein the plurality of ventilation paths are arranged in an oblique-lattice manner.

18. The display device according to claim 17, wherein an interval between the plurality of ventilation paths adjacent to each other is set to 1 to 2 times inclusive of a width of each of the plurality of ventilation paths.
